(19) United States
(12) Patent Application Publication
(10) Pub. No.: US 2020/0005172 A1
(43) Pub. Date: Jan. 2, 2020

(54) SYSTEM AND METHOD FOR GENERATING MULTI-FACTOR FEATURE EXTRACTION FOR MODELING AND REASONING

(71) Applicant: PAYPAL, INC., San Jose, CA (US)

(72) Inventors: Fan Cai, Shanghai (CN); Huagang Yin, Shanghai (CN); Liu Ming Hua, Shanghai (CN); Dan Xu, Shanghai (CN); Hongxia Li, Shanghai (CN); Li Chanchan, Hubei Province (CN)

(21) Appl. No.: 16/022,693

(22) Filed: Jun. 29, 2018

(51) Int. Cl. G06N 5/04; G06Q 10/06; G06F 17/15; G06N 99/00

(52) U.S. Cl. CPC G06N 5/045; G06N 99/005; G06F 17/15; G06Q 10/0635

(57) ABSTRACT

Aspects of the present disclosure involve systems, methods, devices, and the like for generating a cross-factor model for feature extraction and reasoning. In one embodiment, a system is introduced that can identify a combination of two or more variables associated with an event which can be used for determining a reason for an occurrence of the event. In another embodiment, the collection of cross-factor variables identified are used in conjunction with a model such that the model output provides features associated with the event as well as a reasoning behind the event.

### TECHNICAL FIELD

The present disclosure generally relates to multi-factor modeling in communication systems, and more specifically, to generating a multi-factor feature extraction model for decision and reasoning in communication systems.

### BACKGROUND

Nowadays millions and millions of electronic transactions occur on a daily basis. As such, a large amount of transactions can be associated with a risk, event, or other occurrence requiring internal review and assessment by a financial institution. In some instances, an innocuous transaction may enable an unnecessary risk event which may lead to an internal investigation, loss of time, money, and resources. For example, consider the occasion where a user registers for an account, however decides not to follow through or does not use the account. As another example, consider an event where a user bought a new home and initiates a purchase using a zip code that does not match the information in the account. In those instances, a system may identify the event as a possible fraudulent event or high risk occurrence, which can immediately lead to losses which cannot be immediately remediated using conventional methods. Therefore, it would be beneficial to create a system or method that can enable real-time detection and reasoning of risk events.

### BRIEF DESCRIPTION OF THE FIGURES

FIG. 1 illustrates a decision tree structure and clustering for decision making.

FIG. 2 illustrates a flowchart for generating multi-feature extraction factors.

FIG. 3A illustrates an exemplary distribution of a variable used for event analysis.

FIG. 3B illustrates another exemplary distribution of a variable used for event analysis.

FIG. 3C illustrates a chart illustrating a cross-factor between two variables for event analysis.

FIG. 4 illustrates a flow diagram illustrating operations for generating cross-factor model for feature extraction and reasoning.

FIG. 5A illustrates a sample model run illustrating model coverage for generating a cross-factor model for feature extraction and reasoning.

FIG. 5B illustrates a sample model run illustrating model accuracy for generating a cross-factor model for feature extraction and reasoning.

FIG. 6 illustrates a block diagram of a system for generating a cross-factor model for feature extraction and reasoning.

FIG. 7 illustrates an example block diagram of a computer system suitable for implementing one or more devices of the communication systems of FIGS. 1-6.

Embodiments of the present disclosure and their advantages are best understood by referring to the detailed description that follows. It should be appreciated that like reference numerals are used to identify like elements illustrated in one or more of the figures, whereas showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Aspects of the present disclosure involve systems, methods, devices, and the like for generating a cross-factor model for feature extraction and reasoning. In one embodiment, a system is introduced that can identify a combination of two or more variables associated with an event which can be used for determining a reason for an occurrence of the event. The identification of the two or more variables can include a combination of event distributions, information value analysis, and machine learning analysis. In another embodiment, the collection of cross-factor variables identified are used in conjunction with a model such that the model output provides features associated with the event as well as a reasoning behind the event.

Financial institutions are constantly involved in ensuring client accounts are safe and risk is minimized. To safeguard client accounts, financial institutions may rely on the use of event triggers which notify members of the institution that a risk exists. Such triggers can arise from a bad IP address, the use of an account that has been sedentary for an extended period of time, incorrect routing number, etc. As such, team members within the financial institution, organization, third-party service provider, or the like (from here on out financial institution will be used), consider the event and try to identify the factors that contributed to the event. In one embodiment, a team within the financial institution can consider various risk indicators in an effort to identify and determine where the risk exists.

Conventional systems however, are currently not integrated in such a way that enable an immediate indication of risk. Additionally, due to hardware limitations, not all indicators may be able to be provided by the current system and/or computer. Still further, once the indicators are determined, the system may fail to provide reasoning behind the various risk events. That is to say, in conventional systems, the system understands that a risk event exists, but reasoning behind the risk event is not understood. To resolve risk events, current systems often have to create a large number of risk models which can lead to a solution that is complex, expensive, and incomplete. Therefore, it would be beneficial to introduce a system and method that can capture all risk indicators to leverage their information fully and help provide a more meaningful and complete solution.

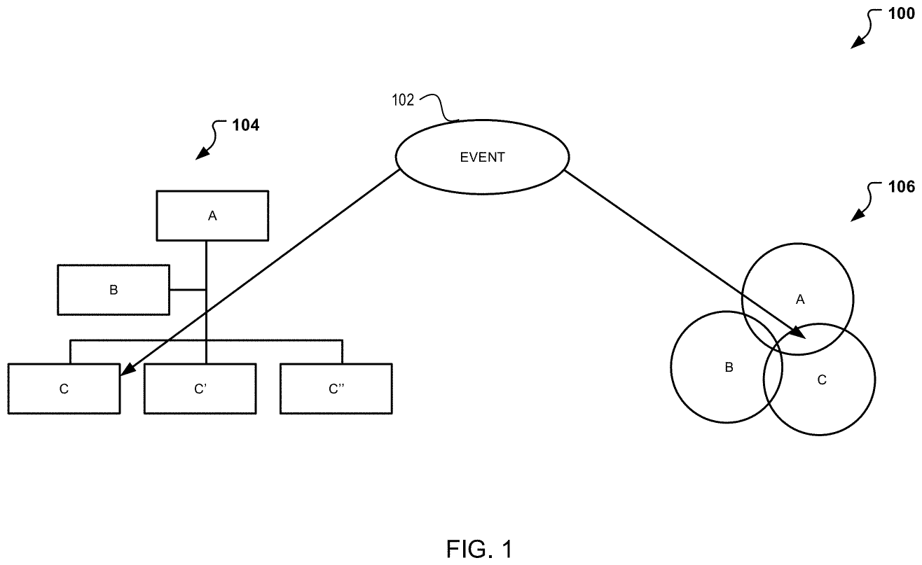

For example, consider FIG. 1 as an illustration. FIG. 1 is introduced which illustrates a decision system 100 with decision tree structures and clusters for decision making. Oftentimes, in analyzing large amounts of data, machine learning algorithms are implemented and used for decision making. Two popular decision making algorithms include the use of decision trees 104 and/or clustering 106 for making a decision on a specific event 102. However, conventional systems, often require the use of multiple models, to identify various factors with each possibly generating a distinct decision for an event 102.

In one embodiment, a model is developed which can take various variables and combines them together in an effort to identify event risk scores. That is to say a model is developed which uses the variables combined to build a multi-factor storage space with feature extraction which provides a measure of how risky or not an event may be. For example, as indicated, multiple factor indicators can exist when a risky event occurs, however, oftentimes multiple models are run, indicators identified and then used to try and determine why a risk event occurred. Here, instead, a single model is created which gives an indication of a risky event occurrence and reasoning behind why the event is risky. Thus, in one embodiment, a model is created to provide information on why an event (e.g., risky event) occurred, how to handle the event, and why the model believes the event is risky. Which is unlike conventional systems, where the object becomes trying to find a best fit for the scenario or reason why the event occurred.

Hence, the model introduced behaves more like decision system 100, where the node A may lead to various branches and identify the correct leave with resulting in the risk event. In general, a decision tree 104 illustrates the mapping of relationships and observations in order to arrive at a conclusion(s). Generally, decision trees can be described in terms of three components, a root node, leaves, and branches. The root node can be the starting point of the tree followed by the branches and leaves which indicate the possible outcomes. Similarly, a clustering 106 mechanism can be used where various cross-factors variables generated are indicative of the event and provide a reason for the event. In other words, a model is introduced that provide a description or “story” explaining the event.

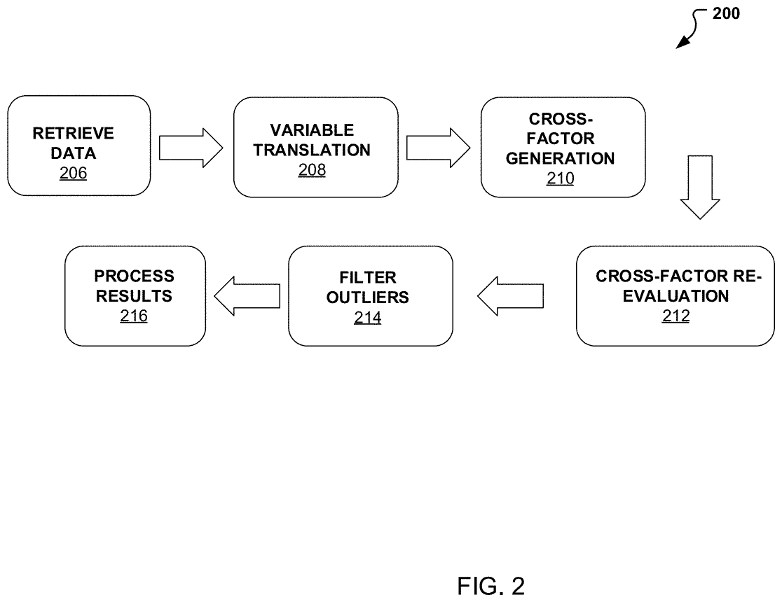

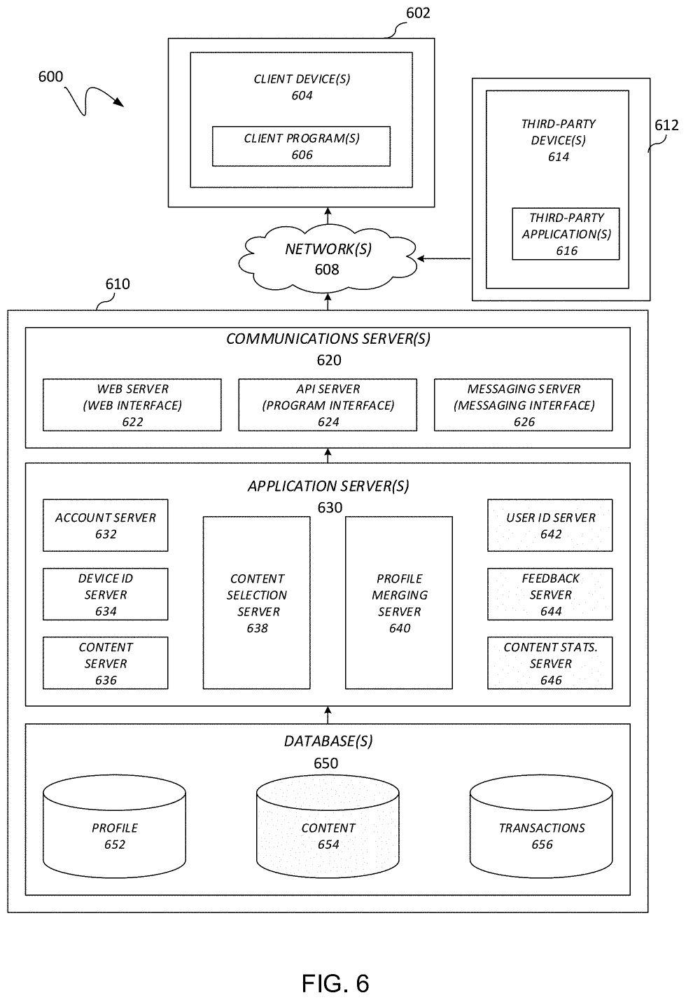

To illustrate how the model arrives at the “story”, FIG. 2 is introduced which illustrates an example process 200 that may be implemented on a system, such as system 600 in FIG. 6. In particular, FIG. 200 illustrates a flow for generating multi-feature extraction factors. A first step in flow 200 includes the data retrieval 206 step. Here, data retrieval can include the obtaining details, information, and other relevant data that can arise during an event. In some instances, the data retrieved can include both relevant and non-relevant information relative to a determination that an event is risky.

Upon retrieving the information, the information may be categorized, organized, and/or analyzed to create/define variables considered useful in event analysis (e.g., in the determination that an event is risky). Therefore, the information retrieved is translated into variables which once defined can be filtered, stored, and stored. Note that the variables defined here include the combination of two or more variables which are combined to create new cross-variables 210. These cross-variables are a combination of two or more variables tailored for various possible events (e.g., setting up an account, credit card payments, online transactions, etc.). Thus, for a payment provider service for example, variables may be crossed based on current transactions, time of transactions, lost user engagement, current engagement, and the like, generating new variable cross-combinations or cross-factor generation 210.

Note that prior to, in conjunction with, or after the definition of the cross-variables, various variable combinations may be tested, expanded (include additional variables), filtered, and simulated to determine if a good fit exists. Alternatively, once the cross-factors have been generated, the cross-factor variables may be re-evaluated 212. This re-evaluation step can include the execution of a check manually or computationally by the current team or platform and/or by the original organizations from which the information was retrieved. This re-evaluation can occur as a standalone evaluation of the cross-factor variables created and provided without disclosure of the information values. Evaluating the cross-factor variables in this manner can provide for an unbias evaluation of the variables and used as a cross-check to those whose information values were high.

Once the cross-factor variables are re-evaluated, outliners may be filtered 214 to ensure those variables selected and used in the model provide the best fit. Finally, the multi-factor variables are used with the model and used to process results 216. That is to say, the newly generated multi-variate factors generated are used in conjunction with at least some of the variables identified to create a model that provides features associated with an event, an indication of an event occurring and a reasoning for the event.

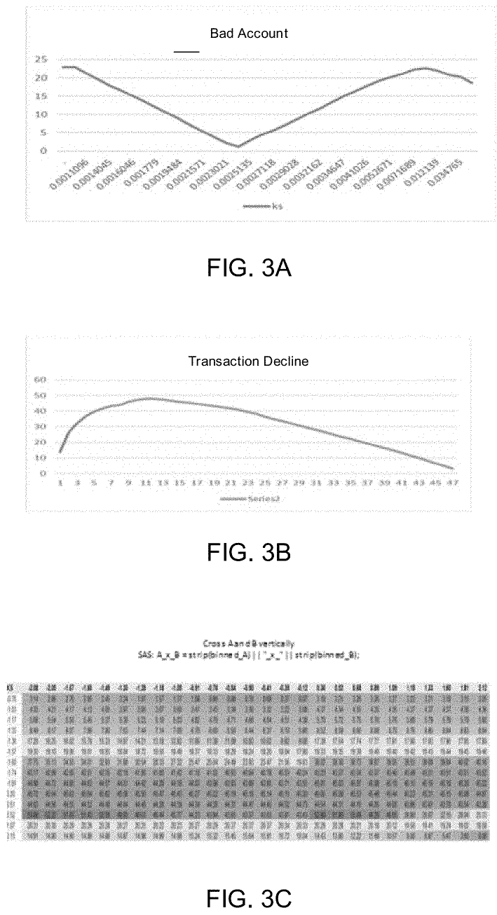

Turning to FIGS. 3A-3C, cross-factor generation analysis is illustrated, as discussed above and in conjunction with cross-factor generation 210. In particular, FIGS. 3A-3B illustrate exemplary distributions of two variable used in event analysis. As indicated, information is retrieved and from the information, variables are identified which can be paired/combined for cross-factor generation used in determining a cause of an event. Here, in FIG. 3A, a distribution of a first variable (e.g., bad account) is plotted for further analysis. As an example, the distribution of the risk level for the variable bad account is plotted in FIG. 3A. The plot illustrates a variable that is riskier about the edges. Similarly, a corresponding distribution for a second variable (e.g., transaction decline) is plotted and illustrated in FIG. 3B. As another example, the risk level distribution is plotted for a transaction decline variable. As illustrated, independently, each of these variables provide almost opposing distributions which generally may not be considered related. However, if the two variables are combined, it may be determined otherwise. For example, consider FIG. 3C, which is a chart illustrating a cross-factor between two variables for event analysis. The chart illustrating the cross-of the two variables, may include a heat map where the axis represents each of the variables. Thus, the heat map may be used to indicate how the two variables may be related. For example, assuming the two variables cross each other vertically, then it can be stated that the red cells on the map represent a greater level of risk, while the green cells may represent less risk. Thus, the cross-variable distribution can now be used to provide some insight as the reason a risky event occurred if it is determined that the event included the two variables and/or a high risk value. In other words, the cross between the variables is able to capture consistencies between the two or more variables that may separately looked weak. Hence, a time series and consistencies between variables may be captured.

Further to the distribution and cross-variable plot for multiple variables, a risk or other threshold value may be provided to aid in the analysis and to make a determination as to the reason an event occurred. To determine such value, the information value may be used and determined for the variables. Information value is a technique that may be used for variable selection during model building. The information value may be determined by using weights of evidence (WoE) for the variables that are combined. Generally, WoE is a value that may be used to measure the strength of a grouping (e.g., combining two variables) for separating a good and a bad risk. Thus, information values may be used to determine for example, may be used to predict the risk of a loan defaulting. As an example, the Information Value for the cross-factors of the model may be determined as a function of the WoE and defined by:

$$WoE = ln ( \frac{\frac{\# {B}_{i}}{\# {B}_{T}}}{\frac{\# {G}_{i}}{\# {G}_{T}}} )$$

$${IV}_{i} = ( \frac{\# {B}_{i}}{\# {B}_{T}} - \frac{\# {G}_{i}}{\# {G}_{T}} ) * WoE$$

$$IV = {\sum }_{k = 0}^{n} {IV}_{i}$$

where the value of WoE will be 0 if the odds of the probability of goods/probability of bads is 1. The value of WoE will be a positive value if the probability of bads in a group is greater than the probability of goods and the value of WoE will be a negative value if the probability of goods is greater than the probability of bads in a group. Thus, a measure of how well the two or more variables cross may be measured using the information value, with a higher information value representing a higher risk prediction. Alternatively, a low information value for a pair of more variables indicates a lower risk prediction. Therefore, in evaluating the variables most optimal for use in the model, those pairs with a lower IV may be eliminated.

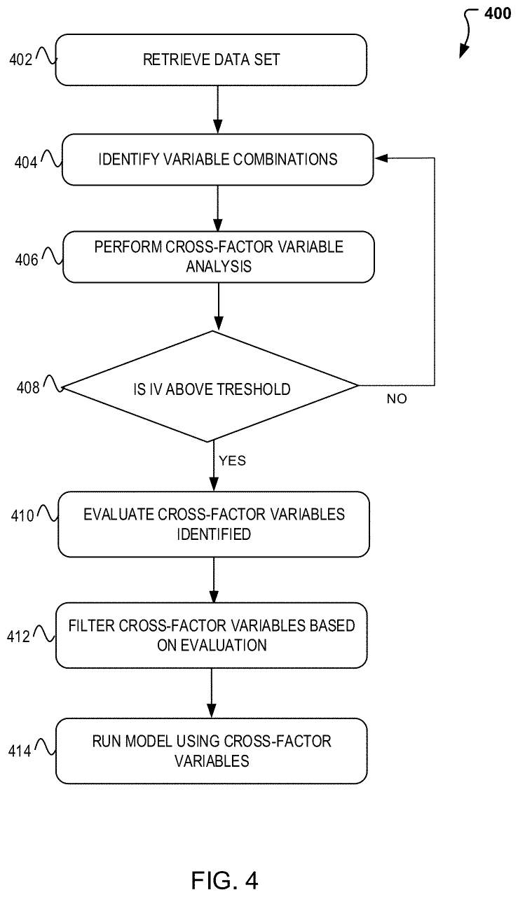

Turning to FIG. 4, the overall process for creating this model. In particular, FIG. 4 illustrates a flow diagram illustrating operations for generating cross-factor model for feature extraction and reasoning. According to some embodiments, process 400 may include one or more of operations 402-414, which may be implemented, at least in part, in the form of executable code stored on a non-transitory, tangible, machine readable media that, when run on one or more hardware processors, may cause a system to perform one or more of the operations 402-414.

Process 400 may begin with operation 402, where data is retrieved. The data retrieved may come in the form of a user data set, user transaction information, account information, buyer information, seller information, and other information available to a group, organization, team or other entity during an event. In some instances, the data retrieved is historical data, while in other instances, the data may be current. Following retrieval of the data, the data retrieved may then be preprocessed at operation 404 for identifying variable combinations which may combined and used in providing a user information on an event. Identifying the variable combinations may include formatting or organizing the data retrieved in such a way that it may be input into a machine learning model for analysis and prediction. In some embodiments, to determine if the two or more variables combined are relevant and/or should be used, cross-factor variable analysis may be performed at operation 406. At operation 406, the variable risk or other event distributions may be used for the analysis as a standalone or in conjunction with other measurements including the cross-analysis using maps, graphs, charts, or other plots that provide insight into how the two or more variables correlate, distributions cross, etc. Additionally or alternatively, event measurements (e.g., measurements) or other valued threshold may be used in the analysis. For example, information values may be used with the variables to provide insight as to a probability associated with an occurrence.

As process 400 continues, a determination is made as to whether the combination of the two or more variables is relevant to the event considered. As an example, in the case where the information value is measured for the variables crossed, if the information value is below a threshold value, then the variables may be sent back to the larger pool for use in other variable combinations. Alternatively, if the information value meets the criteria, then those variables meeting the threshold will be evaluated dynamically, manually, or by the entities from where the information was retrieved for further analysis. That is to say, those variables which met the criteria will be evaluated to ensure usefulness and relevance in the analysis. Outliers will be filtered at operation 412, and the final set of cross-factor variables will be used in the model and for event analysis at operation 414.

Note that process 400 may include additional operations and/or varying sequence in the process. For example, as an alternative in the analysis, re-evaluation of the cross-factor variables identified by occur prior to the determination of the information value and/independent of it. Such that both the IV results and the external results may be considered independently and used in filtering. In addition, although a risk event a generally discussed throughout, the system model and variable generation may be applicable to other events and applications in addition to the identification of the cross-variables, where other techniques may be used and contemplated.

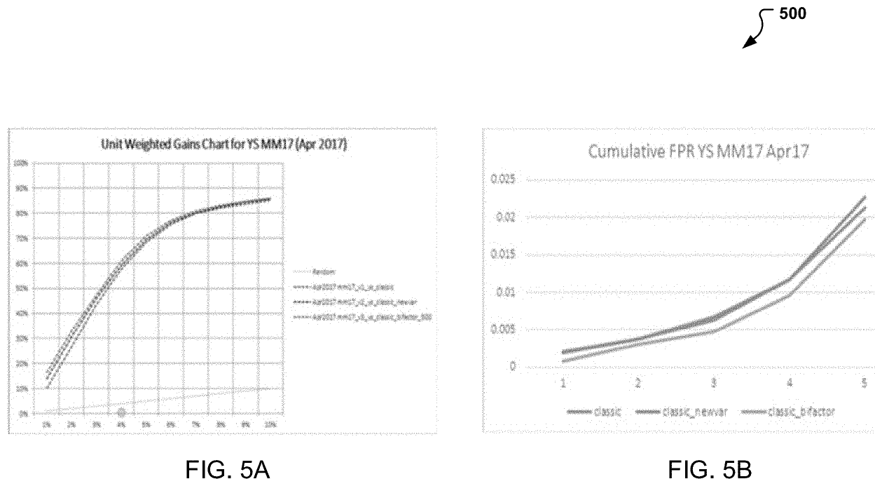

In order to ensure that process 400 was successfully implemented, and proper reasoning was obtained FIGS. 5A-5B are presented. In particular, the impact on the new bi-factor feature extraction and reasoning estimation is plotted and performance measured. FIG. 5A presents the gains and coverage achieved using the novel bi-factor modeling. As illustrated in the figure, a conventional random run performs poorly with minimal gain with increase in coverage when compared with the bi-factor method. Additionally, it was illustrated that the no change in the number of variables used in the cross-factor model was seen despite having added new bi-factor variables. For example, a machine model 17 may be used which operates with approximately 500 variables. In one embodiment, about 400 new bi-factor variables may be created and at least a portion of them swapped with previously used single variables. Thus, minimal or no complexity is introduced with the implementation of the bi-factor variables.

Therefore, process 400 may be successfully implemented to provide risk analysis and risk reasoning and assessments. For example, FIG. 5B further illustrates the lift in accuracy achieved as the bi-factor method is implemented and accuracy in event detection is increased.

Note that other analysis and predictions are possible using process 400. As an example, multiple factors may be used, new stories may be created, new factor combinations may be created, etc.

Note that additional parameters and uses are further available for use with bi-factor feature method extraction method presented in process 400 and FIGS. 4-5 are presented for illustration purposes. Further, process 400 may be implemented using one or more systems. Therefore, where applicable, various embodiments provided by the present disclosure may be implemented using hardware, software, or combinations of hardware and software. For example, FIG. 6 illustrates, in block diagram format, an example embodiment of a computing environment adapted for implementing a system for generating a multi-factor feature extraction model. As shown, a computing environment 600 may comprise or implement a plurality of servers and/or software components that operate to perform various methodologies in accordance with the described embodiments. Severs may include, for example, stand-alone and enterprise-class servers operating a server operating system (OS) such as a MICROSOFT® OS, a UNIX® OS, a LINUX® OS, or other suitable server-based OS. It may be appreciated that the servers illustrated in FIG. 6 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing environment 600 may include, among various devices, servers, databases and other elements, one or more clients 602 that may comprise or employ one or more client devices 604, such as a laptop, a mobile computing device, a tablet, a PC, a wearable device, desktop and/or any other computing device having computing and/or communications capabilities in accordance with the described embodiments. Client devices 604 may include a cellular telephone, smart phone, electronic wearable device (e.g., smart watch, virtual reality headset), or other similar mobile devices that a user may carry on or about his or her person and access readily. Alternatively, client device 604 can include one or more machines, processor, or the like for processing, authorizing, modeling, and performing transactions that may be monitored.

Client devices 604 generally may provide one or more client programs 606, such as system programs and application programs to perform various computing and/or communications operations. Some example system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Some example application programs may include, without limitation, a web browser application, messaging applications (e.g., e-mail, IM, SMS, MMS, telephone, voicemail, VoIP, video messaging, internet relay chat (IRC)), contacts application, calendar application, electronic document application, database application, media application (e.g., music, video, television), location-based services (LBS) applications (e.g., GPS, mapping, directions, positioning systems, geolocation, point-of-interest, locator) that may utilize hardware components such as an antenna, and so forth. One or more of client programs 606 may display various graphical user interfaces (GUIs) to present information to and/or receive information from one or more users of client devices 604. In some embodiments, client programs 606 may include one or more applications configured to conduct some or all of the functionalities and/or processes discussed below.

As shown, client devices 604 may be communicatively coupled via one or more networks 608 to a network-based system 610. Network-based system 610 may be structured, arranged, and/or configured to allow client 602 to establish one or more communications sessions between network-based system 610 and various computing devices 604 and/or client programs 606. Accordingly, a communications session between client devices 604 and network-based system 610 may involve the unidirectional and/or bidirectional exchange of information and may occur over one or more types of networks 608 depending on the mode of communication. While the embodiment of FIG. 6 illustrates a computing environment 600 deployed in a client-server operating relationship, it is to be understood that other suitable operating environments, relationships, and/or architectures may be used in accordance with the described embodiments.

Data communications between client devices 604 and the network-based system 610 may be sent and received over one or more networks 608 such as the Internet, a WAN, a WWAN, a WLAN, a mobile telephone network, a landline telephone network, personal area network, as well as other suitable networks. For example, client devices 604 may communicate with network-based system 610 over the Internet or other suitable WAN by sending and or receiving information via interaction with a web site, e-mail, IM session, and/or video messaging session. Any of a wide variety of suitable communication types between client devices 604 and system 610 may take place, as will be readily appreciated. In particular, wireless communications of any suitable form may take place between client device 604 and system 610, such as that which often occurs in the case of mobile phones or other personal and/or mobile devices. For example an engagement with a third party payment provider, a credit card application or transaction, etc.

In various embodiments, computing environment 600 may include, among other elements, a third party 612, which may comprise or employ third-party devices 614 hosting third-party applications 616. In various implementations, third-party devices 614 and/or third-party applications 616 may host applications associated with or employed by a third party 612. For example, third-party devices 614 and/or third-party applications 616 may enable network-based system 610 to provide client 602 and/or system 610 with additional services and/or information, such as merchant information, data communications, payment services, security functions, customer support, and/or other services, some of which will be discussed in greater detail below. Third-party devices 614 and/or third-party applications 616 may also provide system 610 and/or client 602 with other information and/or services, such as email services and/or information, property transfer and/or handling, purchase services and/or information, and/or other online services and/or information and other processes and/or services that may be processes and monitored by system 610.

In one embodiment, third-party devices 614 may include one or more servers, such as a transaction server that manages and archives transactions. In some embodiments, the third-party devices may include a purchase database that can provide information regarding purchases of different items and/or products. In yet another embodiment, third-party severs 614 may include one or more servers for aggregating consumer data, purchase data, and other statistics.

Network-based system 610 may comprise one or more communications servers 620 to provide suitable interfaces that enable communication using various modes of communication and/or via one or more networks 608. Communications servers 620 may include a web server 622, an API server 624, and/or a messaging server 626 to provide interfaces to one or more application servers 630. Application servers 630 of network-based system 610 may be structured, arranged, and/or configured to provide various online services, merchant identification services, merchant information services, purchasing services, monetary transfers, checkout processing, data gathering, data analysis, and other services to users that access network-based system 610. In various embodiments, client devices 604 and/or third-party devices 614 may communicate with application servers 630 of network-based system 610 via one or more of a web interface provided by web server 622, a programmatic interface provided by API server 624, and/or a messaging interface provided by messaging server 626. It may be appreciated that web server 622, API server 624, and messaging server 626 may be structured, arranged, and/or configured to communicate with various types of client devices 604, third-party devices 614, third-party applications 616, and/or client programs 606 and may interoperate with each other in some implementations.

Web server 622 may be arranged to communicate with web clients and/or applications such as a web browser, web browser toolbar, desktop widget, mobile widget, web-based application, web-based interpreter, virtual machine, mobile applications, and so forth. API server 624 may be arranged to communicate with various client programs 606 and/or a third-party application 616 comprising an implementation of API for network-based system 610. Messaging server 626 may be arranged to communicate with various messaging clients and/or applications such as e-mail, IM, SMS, MMS, telephone, VoIP, video messaging, IRC, and so forth, and messaging server 626 may provide a messaging interface to enable access by client 602 and/or third party 612 to the various services and functions provided by application servers 630.

Application servers 630 of network-based system 610 may be a server that provides various services to clients including, but not limited to, data analysis, geofence management, order processing, checkout processing, data modeling, and/or the like. Application server 630 of network-based system 610 may provide services to a third party merchants such as real time consumer metric visualizations, real time purchase information, and/or the like. Application servers 630 may include an account server 632, device identification server 634, payment server 636, queue analysis server 638, purchase analysis server 640, user ID server 642, feedback server 644, and/or content statistics server 646. These servers, which may be in addition to other servers, may be structured and arranged to configure the system for monitoring queues as well as running and storing learning information for the decision ensemble tree processing.

Application servers 630, in turn, may be coupled to and capable of accessing one or more databases 650 including a profile database 652, content database 654, transactions database 656, and/or the like. Databases 650 generally may store and maintain various types of information for use by application servers 630 and may comprise or be implemented by various types of computer storage devices (e.g., servers, memory) and/or database structures (e.g., relational, object-oriented, hierarchical, dimensional, network) in accordance with the described embodiments.

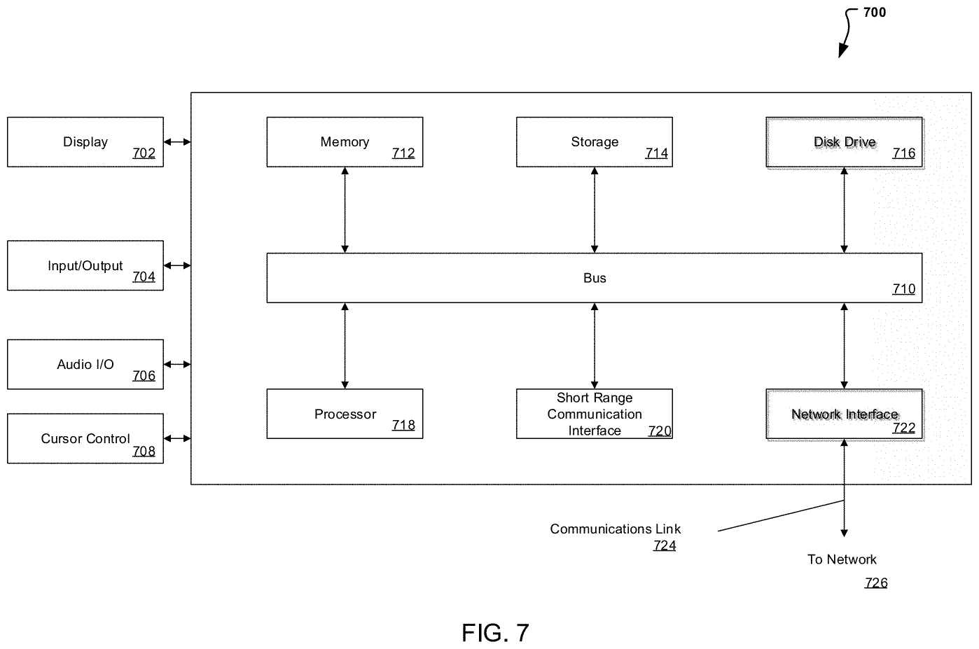

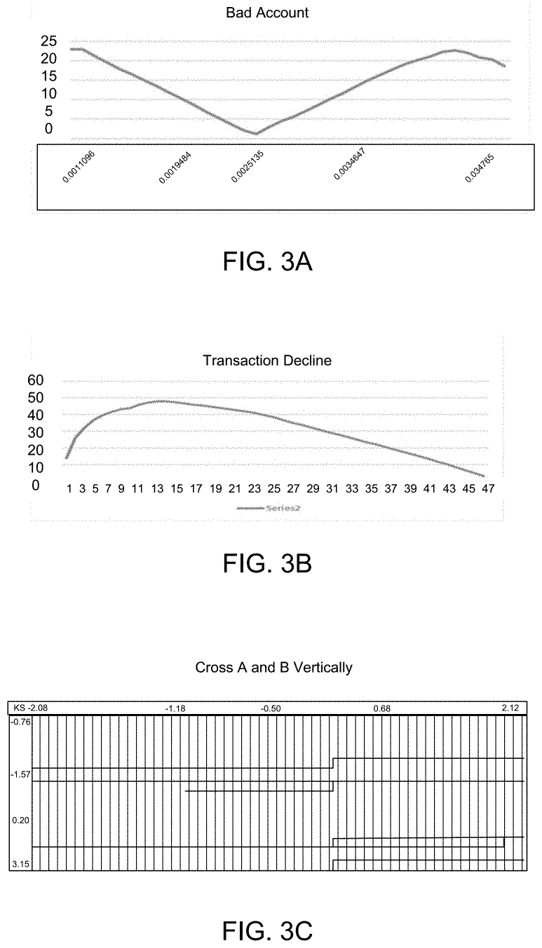

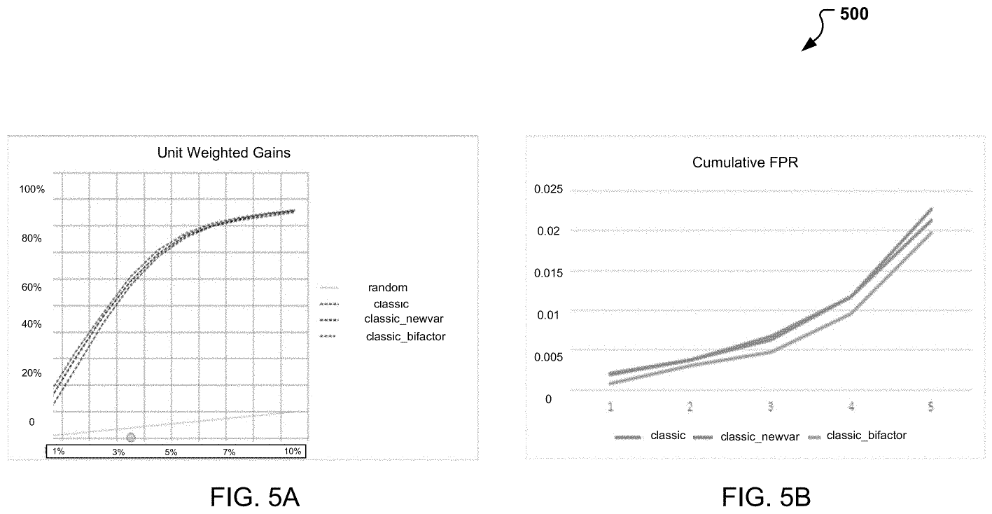

FIG. 7 illustrates an example computer system 700 in block diagram format suitable for implementing on one or more devices of the system in FIGS. 1-6. In various implementations, a device that includes computer system 700 may comprise a personal computing device (e.g., a smart or mobile device, a computing tablet, a personal computer, laptop, wearable device, PDA, server system, etc.) that is capable of communicating with a network 726. A service provider and/or a content provider may utilize a network computing device (e.g., a network server) capable of communicating with the network. It should be appreciated that each of the devices utilized by users, service providers, and content providers may be implemented as computer system 700 in a manner as follows.

Additionally, as more and more devices become communication capable, such as new smart devices using wireless communication to report, track, message, relay information and so forth, these devices may be part of computer system 700. For example, windows, walls, and other objects may double as touch screen devices for users to interact with. Such devices may be incorporated with the systems discussed herein.

Computer system 700 may include a bus 710 or other communication mechanisms for communicating information data, signals, and information between various components of computer system 700. Components include an input/output (I/O) component 704 that processes a user action, such as selecting keys from a keypad/keyboard, selecting one or more buttons, links, actuatable elements, etc., and sending a corresponding signal to bus 710. I/O component 704 may also include an output component, such as a display 702 and a cursor control 708 (such as a keyboard, keypad, mouse, touchscreen, etc.). In some examples, I/O component 704 other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 718, which may be a micro-controller, digital signal processor (DSP), or other processing component, that processes these various signals, such as for display on computer system 700 or transmission to other devices over a network 726 via a communication link 724. Again, communication link 724 may be a wireless communication in some embodiments. Processor 718 may also control transmission of information, such as cookies, IP addresses, images, transaction information, learning model information, SQL support queries, and/or the like to other devices.

Components of computer system 700 also include a system memory component 712 (e.g., RAM), a static storage component 714 (e.g., ROM), and/or a disk drive 716. Computer system 700 performs specific operations by processor 718 and other components by executing one or more sequences of instructions contained in system memory component 712 (e.g., for engagement level determination). Logic may be encoded in a computer readable medium, which may refer to any medium that participates in providing instructions to processor 718 for execution. Such a medium may take many forms, including but not limited to, non-volatile media, volatile media, and/or transmission media. In various implementations, non-volatile media includes optical or magnetic disks, volatile media includes dynamic memory such as system memory component 712, and transmission media includes coaxial cables, copper wire, and fiber optics, including wires that comprise bus 710. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, hard disk, magnetic tape, any other magnetic medium, CD-ROM, any other optical medium, RAM, PROM, EPROM, FLASH-EPROM, any other memory chip or cartridge, or any other medium from which a computer is adapted to read.

Components of computer system 700 may also include a short range communications interface 720. Short range communications interface 720, in various embodiments, may include transceiver circuitry, an antenna, and/or waveguide. Short range communications interface 720 may use one or more short-range wireless communication technologies, protocols, and/or standards (e.g., WiFi, Bluetooth®, Bluetooth Low Energy (BLE), infrared, NFC, etc.).

Short range communications interface 720, in various embodiments, may be configured to detect other devices (e.g., user device, etc.) with short range communications technology near computer system 700. Short range communications interface 720 may create a communication area for detecting other devices with short range communication capabilities. When other devices with short range communications capabilities are placed in the communication area of short range communications interface 720, short range communications interface 720 may detect the other devices and exchange data with the other devices. Short range communications interface 720 may receive identifier data packets from the other devices when in sufficiently close proximity. The identifier data packets may include one or more identifiers, which may be operating system registry entries, cookies associated with an application, identifiers associated with hardware of the other device, and/or various other appropriate identifiers.

In some embodiments, short range communications interface 720 may identify a local area network using a short range communications protocol, such as WiFi, and join the local area network. In some examples, computer system 700 may discover and/or communicate with other devices that are a part of the local area network using short range communications interface 720. In some embodiments, short range communications interface 720 may further exchange data and information with the other devices that are communicatively coupled with short range communications interface 720.

In various embodiments of the present disclosure, execution of instruction sequences to practice the present disclosure may be performed by computer system 700. In various other embodiments of the present disclosure, a plurality of computer systems 700 coupled by communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link 724 and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. It is also contemplated that software identified herein may be implemented using one or more computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on the user and user device, however, a customer, a merchant, a service or payment provider may otherwise presented with tailored information. Thus, “user” as used herein can also include charities, individuals, and any other entity or person receiving information. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing instructions; and
a processor configured to execute instructions to cause the system to:
in response to a determination that new data is available for processing, retrieve a set of data associated with an event;
identify, variables associated with the set of data retrieved;
analyze the variables identified using a cross-factor variable analysis on two or more of the variables;
identify cross-factor variables for describing the event;
filter, the cross-factor variables that do not meet a threshold value criteria; and
run, a cross-factor model using the filtered cross-factor variables for making a prediction on the event.

2. The system of claim 1, executing instructions further causes the system to:
evaluate the cross-factor variables identified to verify that the two or more variables are a correct match, where the correct match is determined by computing an information value for each of the cross-factor variables identified.

3. The system of claim 1, executing instructions further causes the system to:
evaluate the cross-factor variables identified to verify that the two or more variables selected are a correct match, where the correct match is determined by performing a cross-factor distribution analysis using a heat map.

4. The system of claim 3, wherein the cross-factor model outputs features and a reasoning for the event.

5. The system of claim 1, executing instructions further causes the system to:
re-evaluate the cross-factor variables identified independent of the threshold value criteria, wherein re-evaluate includes selecting the cross-factor variables that include a high correlation to an event.

6. The system of claim 5, wherein the filtering of the cross-factor variables can include the filtering out of the cross-factor variables that are not selected during re-evaluation of the cross-factor variables.

7. The system of claim 5, wherein the re-evaluate of the cross-factor variables includes evaluation of the cross-factor variables independent of the threshold value criteria.

8. A method comprising:
in response to determining that new data is available for processing, retrieving a set of data associated with an event;
identifying, variables associated with the set of data retrieved;
analyzing the variables identified using a cross-factor variable analysis on two or more of the variables;
identifying cross-factor variables for describing the event;
filtering, the cross-factor variables that do not meet a threshold value criteria; and
running, a cross-factor model using the filtered cross-factor variables for making a prediction on the event.

9. The method of claim 8, further comprising:
evaluating the cross-factor variables identified to verify that the two or more variables selected are a correct match, where the correct match is determined by computing an information value for each of the cross-factor variables identified.

10. The method of claim 8, further comprising:
evaluating the cross-factor variables identified to verify that the two or more variables selected are a correct match, where the correct match is determined by performing a cross-factor distribution analysis using a heat map.

11. The method of claim 8, wherein the cross-factor model outputs features and a reasoning for the event.

12. The method of claim 8, further comprising:
re-evaluating the cross-factor variables identified independent of the threshold value criteria, wherein re-evaluate includes selecting the cross-factor variables that include a high correlation to an event.

13. The method of claim 12, wherein the filtering of the cross-factor variables can include the filtering out of the cross-factor variables that are not selected during re-evaluation of the cross-factor variables.

14. The method of claim 12, wherein the re-evaluating of the cross-factor variables includes evaluation of the cross-factor variables independent of the threshold value criteria.

15. A non-transitory machine readable medium having stored thereon machine readable instructions executable to cause a machine to perform operations comprising:
in response to determining that new data is available for processing, retrieving a set of data associated with an event;
identifying, variables associated with the set of data retrieved;
analyzing the variables identified using a cross-factor variable analysis on two or more of the variables;
identifying cross-factor variables for describing the event;
filtering, the cross-factor variables that do not meet a threshold value criteria; and
running, a cross-factor model using the filtered cross-factor variables for making a prediction on the event.

16. The non-transitory medium of claim 15, further comprising:
evaluating the cross-factor variables identified to verify that the two or more variables selected are a correct match, where the correct match is determined by computing an information value for each of the cross-factor variables identified.

17. The non-transitory medium of claim 15, further comprising:
evaluating the cross-factor variables identified to verify that the two or more variables selected are a correct match, where the correct match is determined by performing a cross-factor distribution analysis using a heat map.

18. The non-transitory medium of claim 15, wherein the cross-factor model outputs features and a reasoning for the event.

19. The non-transitory medium of claim 15, further comprising:
re-evaluate the cross-factor variables identified independent of the threshold value criteria, wherein re-evaluate includes selecting the cross-factor variables that include a high correlation to an event.

20. The non-transitory medium of claim 19, wherein the filtering of the cross-factor variables can include the filtering out of the cross-factor variables that are not selected during re-evaluation of the cross-factor variables.
